(19) United States
(12) Patent Application Publication
(10) Pub. No.: US 2005/0200858 A1
(43) Pub. Date: Sep. 15, 2005

(54) Contoured inspection plug for low pressure drop

(75) Inventor: Gregory G. Johnson, San Diego, CA (US)

Correspondence Address: Hamilton Sundstrand Corporation, 4747 Harrison Avenue, P.O. Box 7002, Rockford, IL, 61125-7002, US

(73) Assignee: Hamilton Sundstrand Corporation

(21) Appl. No.: 11/044,551

(22) Filed: Jan. 27, 2005

Related U.S. Application Data
(60) Provisional application No. 60/540,126, filed on Jan. 28, 2004.

(51) Int. Cl. G01B 11/24

(52) U.S. Cl. 356/602

(57) ABSTRACT

A special air duct inspection window system that comprises an inspection window and matching removable inspection plug that maintains the low loss three-dimensional contour of the inner walls of the air duct, thereby minimising turbulence and internal pressure drop.

### CROSS REFERENCE TO RELATED APPLICATIONS

This Application claims the benefit of the filing date for prior filed co-pending Provisional Application Ser. No. 60/540,126, filed 28 Jan. 2003.

### FIELD OF THE INVENTION

The invention relates to low loss air ducting systems, and more particularly to a low loss inspection window plug for a compact air duct.

### BACKGROUND OF THE INVENTION

An air duct that couples ambient air to machinery within a compact compartment, such as a plenum seal duct (PSD) that couples an aircraft mounted inlet duct (AMID) to an aircraft auxiliary power unit (APU) that is mounted within an aircraft tailcone, often requires a design that affords compact design coupled with low loss, meaning that the PSD has inner walls with a three dimensional contour.

Inspection of an APU inlet screen has required separation of the APU from the AMID, and that has meant that the APU has had to be removed from the tailcone due to the compact design of the PSD. Although it is possible to place an aperture in the PSD to serve as a window for inspection purposes that is plugged during normal use, the aperture would disturb the three dimensional contour of the inner walls and add additional pressure drop due to turbulence of the moving air within the PSD.

### SUMMARY OF THE INVENTION

The present invention overcomes the difficulty in providing APU inlet screen inspection with the utilisation of a special PSD inspection window and matching removable inspection plug that maintains the low loss three-dimensional contour of the inner walls, thereby minimising turbulence and internal pressure drop.

In a preferred embodiment, the invention comprises an inspection window system for an air duct that minimises internal pressure drop, comprising:

an inspection window aperture mounted through a side of the air duct; and

a plug that has an inside inner surface with a contour to match the inner walls of the air duct that couples with the inspection window aperture.

### DESCRIPTION OF THE DRAWINGS

FIG. 1 is an exploded perspective view of a PSD that incorporates an inspection window system according a preferred embodiment of the invention.

FIG. 2 is a perspective view of the complete assembled PSD that incorporates an inspection window system according the preferred embodiment of the invention.

### DESCRIPTION OF THE EMBODIMENT

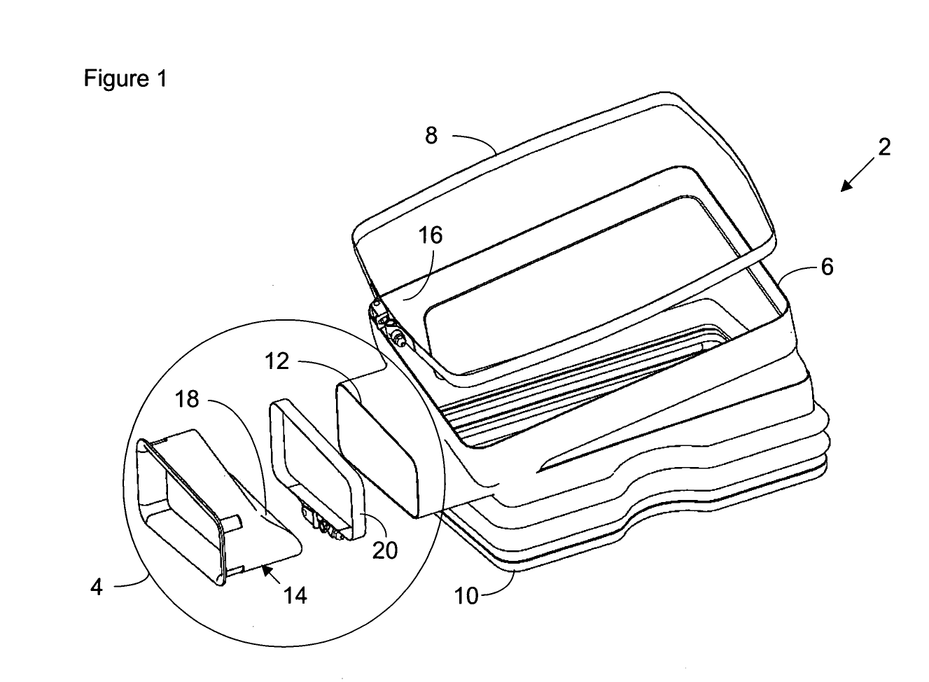

FIG. 1 is an exploded perspective view of a PSD 2 that incorporates an inspection window system 4 according a preferred embodiment of the invention. The PSD 2 has an upper inlet 6 that couples to an AMID in a tail cone (not shown) of an aircraft. A clamp 8 preferably secures the upper inlet 6 of the PSD 2 to the AMID. The PSD 2 has a lower outlet 10 that couples to an inlet of an APU (not shown) mounted within the tailcone. The PSD 2 also has an inspection window aperture 12 mounted through a side of the PSD 2 to provide inspection of an inlet screen for the APU (not shown).

An inspection plug 14 fits into the inspection window aperture 12. The PSD 2 has inner walls 16 that have a three-dimensional taper. The inspection plug 14 has an inner surface 18 that has a contour to match inner walls 16. When the inspection plug 14 fits into the inspection window 12, the contour of its inner surface 18 minimises any abrupt changes to the contour of the inner walls 16 of the PSD 2 that would trigger a corresponding pressure drop within the PSD 2. A clamp 20 preferably secures the inspection plug 18 in place.

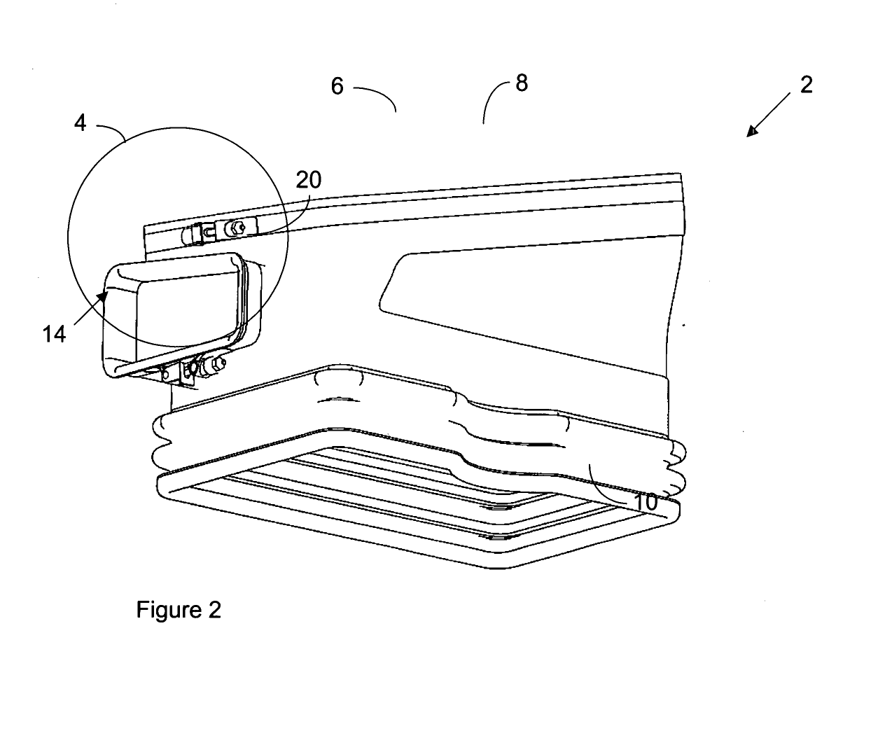

FIG. 2 is a perspective view of the complete assembled PSD 2 that incorporates an inspection window system 4 according to the invention. It shows how the inspection plug 14 fits within the inspection window aperture 12 to provide a smooth flow of air within the PSD2. The removable inspection plug 14 is removed to allow inspection of the APU inlet screen through the inspection window aperture 12.

Described above is a special air duct inspection window system that comprises an inspection window and matching removable inspection plug that maintains the low loss three-dimensional contour of the inner walls of the air duct, thereby minimising turbulence and internal pressure drop. It should be understood that the embodiment described above is only one illustrative implementation of the invention, that the various parts and arrangement thereof may be changed or substituted, and that the invention is only limited by the scope of the attached claims.

1. An inspection window system for an air duct that minimises internal pressure drop, comprising:
an inspection window aperture mounted through a side of the air duct; and
an inspection plug that has an inner surface with a three-dimensional contour to match the inner walls of the air duct that fits into the inspection window aperture.

2. The inspection window system of claim 1, wherein the air duct comprises a plenum seal duct (PSD) for an aeronautical auxiliary power unit (APU).

3. The inspection window system of claim 2, wherein the PSD has an upper inlet that couples to an aircraft mounted inlet duct (AMID) and a lower outlet that couples to an inlet of the APU.

4. The inspection window system of claim 3, wherein the inspection window aperture is mounted through the side of the PSD to allow inspection of an inlet screen for the APU.

5. The inspection window system of claim 4, wherein the inspection plug is removed from the inspection window to allow inspection of the APU inlet screen.

6. The inspection window system of claim 1, wherein the inspection window is mounted through the side of the air duct to allow inspection through an outlet of the air duct.

7. The inspection window system of claim 6, wherein the inspection plug is removed from the inspection window to allow inspection through the air duct outlet.

8. An inspection window system with minimised internal pressure drop for an air duct, comprising:
an inspection window aperture mounted through a side of the air duct to allow inspection through an outlet of the air duct; and
an inspection plug that has an inner surface with a three-dimensional contour to match the inner walls of the air duct that fits into the inspection window aperture and is removed from the inspection window to allow inspection through the air duct outlet.

9. The inspection window system of claim 8, wherein the air duct has an upper inlet and a lower outlet.

10. An inspection window system with minimised internal pressure drop for a plenum seal duct (PSD) that couples an aircraft mounted inlet duct (AMID) to an auxiliary power unit (APU), comprising:
an inspection window aperture mounted through a side of the PSD to allow inspection of an APU inlet screen through an outlet of the PSD; and
an inspection plug that has an inner surface with a three-dimensional contour to match the inner walls of the PSD that fits into the inspection window aperture and is removed from the inspection window to allow inspection of the APU inlet screen through the PSD outlet.

11. The inspection window system of claim 10, wherein the PSD has an upper inlet and a lower outlet.
